(19) United States
(12) Patent Application Publication
(10) Pub. No.: US 2017/0150395 A1
(43) Pub. Date: May 25, 2017

(54) MOBILITY MANAGEMENT OF USER EQUIPMENT

(71) Applicant: TELEFONAKTIEBOLAGET LM ERICSSON (PUBL), Stokholm (SE)

(72) Inventors: Josefin KARLSSON, Torslanda (SE); Ulf MATTSSON, Kungsbacka (SE)

(73) Assignee: TELEFONAKTIEBOLAGET LM ERICSSON (PUBL), Stokholm (SE)

(21) Appl. No.: 15/323,623

(22) PCT Filed: Jul. 4, 2014
(86) PCT No.: PCT/EP2014/064313

§ 371 Date: Jan. 3, 2017

(51) Int. Cl. H04W 28/02; H04M 15/00; H04W 8/26; H04W 4/02; H04W 8/08

(52) U.S. Cl. CPC H04W 28/0284; H04W 4/02; H04W 8/08; H04W 8/26; H04M 15/66

(57) ABSTRACT

There is provided mobility management of user equipment. A radio access network congestion awareness function (RCAF) node requests, from a mobility management node, user equipment identities for user equipment in a specific location. The user equipment identities pertain to user equipment currently in connected state and current state of user equipment previously in connected state. The RCAF node receives, from the mobility management node, a report comprising user equipment identity information (UEII) pertaining at least to idle state user equipment as identifiable by the mobility management node in the specific location. The RCAF node provides a notification comprising the UEII to a policy and charging rules function.

### TECHNICAL FIELD

Embodiments presented herein relate to mobility management of user equipment, and particularly to methods, a radio access network congestion awareness function node, a mobility management node, computer programs, and a computer program product for mobility management of user equipment.

### BACKGROUND

In communications networks, there may be a challenge to obtain good performance and capacity for a given communications protocol, its parameters and the physical environment in which the communications network is deployed.

One parameter of the communications network may be the level of congestion for different parts of the communications network, such as for different cells of a cellular communications network.

It has in solution 1.5.5 in 3GPP TR 23.705 for the Universal Terrestrial Radio Access Network (UTRAN) and the Evolved-UTRAN (E-UTRAN) denoted “off-path based RAN user plane congestion reporting” been suggested that a radio access network congestion awareness function (RCAF) sends the congestion level of the congested cells. In this proposed solution there exists a repetition time determining how often the RCAF sends congestion information to the policy and charging rules function (PCRF). Before sending such information, the RCAF will request from the mobility management entity (MME) what user equipment are in connected state in certain radio access network coverage areas or cells. However, the information sent to the PCRF may not be representative for the time until a next information message is sent from the RCAF to the PCRF.

Hence, there is still a need for an improved mobility management of user equipment.

### SUMMARY

An object of embodiments herein is to provide improved mobility management of user equipment.

According to a first aspect there is presented a method for mobility management of user equipment. The method is performed by a radio access network congestion awareness function (RCAF) node. The method comprises requesting, from a mobility management node, user equipment identities for user equipment in a specific location, the user equipment identities pertaining to user equipment currently in connected state and current state of user equipment previously in connected state. The method comprises receiving, from the mobility management node, a report comprising user equipment identity information (UEII) pertaining at least to idle state user equipment as identifiable by the mobility management node in the specific location. The method comprises providing a notification comprising the UEII to a policy and charging rules function (PCRF).

Advantageously this provides efficient mobility management of user equipment.

Advantageously this increases the possibility for the PCRF to make the right decisions for an increasing number of user equipment. The RCAF has the possibility to keep track of all previously reported user equipment (with available user equipment identity information) to the PCRF, and the RCAF may notify the PCRF if the user equipment are still in the reported specific location (which may be congestion prone) or if the user equipment has/have moved to another specific location (which can be a congestion location or a non-congestion location).

According to a second aspect there is presented an RCAF node for mobility management of user equipment. The RCAF node comprises a processing unit. The processing unit is configured to request, from a mobility management node, user equipment identities for user equipment in a specific location, the user equipment identities pertaining to user equipment currently in connected state and current state of user equipment previously in connected state. The processing unit is configured to receive, from the mobility management node, a report comprising UEII pertaining at least to idle state user equipment as identifiable by the mobility management node in the specific location. The processing unit is configured to provide a notification comprising the UEII to a PCRF.

According to a third aspect there is presented a computer program for mobility management of user equipment, the computer program comprising computer program code which, when run on a processing unit of the RCAF node, causes the processing unit to perform a method according to the first aspect.

According to a fourth aspect there is presented a computer program product comprising a computer program according to the third aspect and a computer readable means on which the computer program is stored.

According to a fifth aspect there is presented a method for mobility management of user equipment. The method is performed by a mobility management node. The method comprises receiving, from an RCAF node, a request for user equipment identities for user equipment in a specific location, the user equipment identities pertaining to user equipment currently in connected state and current state of user equipment previously in connected state. The method comprises providing, to the RCAF node, a report comprising user equipment identity information (UEII) pertaining at least to idle state user equipment as identifiable by the mobility management node in the specific location.

According to a sixth aspect there is presented a mobility management node for mobility management of user equipment. The mobility management node comprises a processing unit. The processing unit is configured to receive, from an RCAF node, a request for user equipment identities for user equipment in a specific location, the user equipment identities pertaining to user equipment currently in connected state and current state of user equipment previously in connected state. The processing unit is configured to provide, to the RCAF node, a report comprising UEII pertaining at least to idle state user equipment as identifiable by the mobility management node in the specific location.

According to a seventh aspect there is presented a computer program for mobility management of user equipment, the computer program comprising computer program code which, when run on a processing unit of the mobility management node causes the processing unit to perform a method according to the fifth aspect.

According to an eight aspect there is presented a computer program product comprising a computer program according to the seventh aspect and a computer readable means on which the computer program is stored.

It is to be noted that any feature of the first, second, third, fourth, fifth, sixth, seventh and eight aspects may be applied to any other aspect, wherever appropriate. Likewise, any advantage of the first aspect may equally apply to the second, third, fourth, fifth, sixth, seventh, and/or eight aspect, respectively, and vice versa. Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic diagram illustrating parts of a radio access network according to embodiments;

FIG. 3a is a schematic diagram showing functional units of a radio access network congestion awareness function node according to an embodiment;

FIG. 3b is a schematic diagram showing functional modules of a radio access network congestion awareness function node according to an embodiment;

FIG. 4a is a schematic diagram showing functional units of a mobility management node according to an embodiment;

FIG. 4b is a schematic diagram showing functional modules of a mobility management node according to an embodiment;

FIG. 5 shows one example of a computer program product comprising computer readable means according to an embodiment; and

FIGS. 6, 7, 8 and 9 are flowcharts of methods according to embodiments; and

FIG. 10 is a signalling diagram according to embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

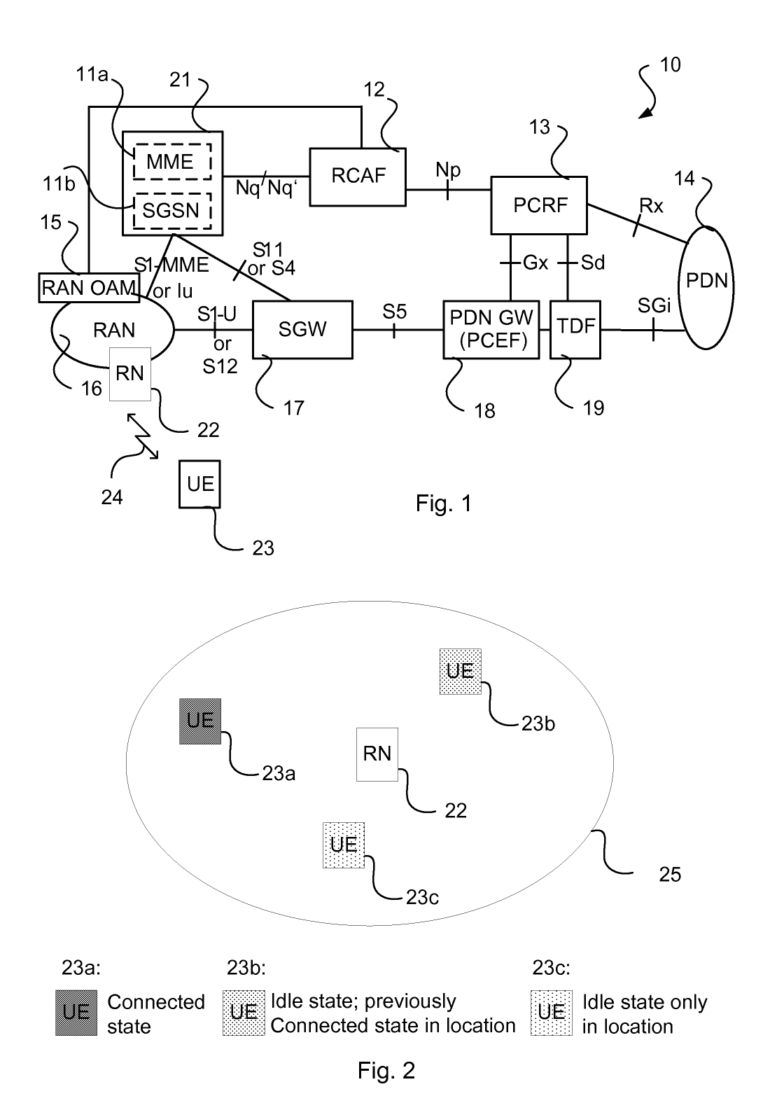

FIG. 1 is a schematic diagram illustrating a communications network 10 where embodiments presented herein can be applied. The communications network 10 of FIG. 1 comprises a number of functional nodes and entities 11a, 11b, 12, 13, 14, 15, 16, 17, 18, 19, 22, and 23. In FIG. 1 also interfaces between the functional nodes and entities are provided. The functionality of the functional nodes and entities 11a, 11b-19, 22, and 23 will be briefly summarized next.

In general terms, the radio access network (RAN) 16 implements a radio access technology (RAT) for a portable wireless device (such as a mobile phone, a terminal equipment, a mobile station, a computer, etc., or any remotely controlled machine), hereinafter collectively referred to as a user equipment (UE) 23, to, via a radio access network node (RN) 22, connect to the communications network 10 over a wireless interface 24. Two examples of RANs 16 are UTRAN and E-UTRAN. Conceptually, the RAN 16 thus resides between the UE 23 and the core network (CN) which is part of the communications network 10.

In general terms, the RAN 16 is associated with an Operations, administration and management/maintenance functionality, denoted RAN OAM 15.

In general terms, the packet data network (PDN) 14 provides services and data to a UE 23 operatively connected to the RAN 16 via the RN 22. The PDN 14 may be the Internet or another wide area network.

In general terms, the serving gateway (SGW) 17 routes and forwards user data packets, whilst also acting as the mobility anchor for the user plane during inter-eNB handovers and as the anchor for mobility between Long Term Evolution (LTE) and other 3GPP technologies, where eNB is short for evolved Node B, the type of radio access network node (RAN node) used in E-UTRAN.

In general terms, the PDN gateway (PDN GW or policy and charging enforcement function (PCEF)) 18 provides connectivity from the UE 23 to external packet data networks, such as the PDN 14, by being the point of exit and entry of traffic for the UE 23.

In general terms, the Policy and Charging Rules Function (PCRF) 13 is a functional entity that encompasses policy control decision and flow based charging control functionalities. The PCRF 13 provides network control regarding the service data flow detection, gating, QoS (Quality of Service) and flow based charging (except credit management) towards the PCEF 18.

In general terms, the Traffic Detection Function (TDF) 19 is a functional entity that performs application detection and reporting of a detected application, e.g. reporting to the PCRF 13 and/or the PDN GW 19. The application may e.g. be an application running on the UE 23 or similar.

In general terms, the serving GPRS support node (SGSN) 11b or Mobility Management Entity (MME) 11a, as part of a mobility management (MM) node 21, is responsible for signalling from and to the UEs 23 within its geographical service area. At least one of the SGSN 11b and the MME 11a may be part of a mobility management (MM) node 21. Its tasks include packet routing and transfer (only applicable for the SGSN 11b), mobility management (attach/detach and location management), logical link management, and authentication and charging functions. It is responsible for idle state UE paging and tagging procedure including retransmissions. It is involved in the bearer activation/deactivation process and is also responsible for choosing the SGW 17 for a UE 23 at the initial attach and at time of intra-LTE handover involving Core Network (CN) node relocation. It is responsible for authenticating the user. Further details of the MM node 21 will be provided below.

In general terms, a RAN congestion awareness function (RCAF) 12, or a similar function, collects (raw) data from the RAN OAM 15, such as congestion information originating from the cells of the RAN (see, FIG. 2 and its description below), and transmits congestion reporting data including the congestion levels to the PCRF 13. Further details of the RCAF 12 will be provided below.

It has in solution 1.5.5 in 3GPP TR 23.705 for the Universal Terrestrial Radio Access Network (UTRAN) and the Evolved-UTRAN (E-UTRAN) been suggested that the RCAF node 12 will at time intervals send congestion information changes per user equipment 23 (or International mobile Subscriber Identities, IMSIs, of such user equipment 23) over the Np interface to the PCRF 13 for a specific location. The specific location may, for example, represent the total network coverage area of one RAN node, such as the total network coverage area of one eNBs, the network coverage of one cell (where one or more RAN nodes may provide network coverage in this one cell), a specific service area identifier, and/or a specific routing area identifier.

The information sent by the RCAF node 12 to the PCRF 13 may comprise congestion level for user equipment 23/IMSIs that suffer from congestion. The information is based on the user equipment 23 that at a certain point in time were in connected state in the specific location and that suffer from congestion. What user equipment that in the particular location were connected at a particular point in time is requested from the MM node 21 by the RCAF node 12, e.g. by using congested RAN nodes or cells as input parameter for the request. The information may be used by the PCRF 13 to initiate certain actions to overcome congestion in the specific location for which the user equipment or IMSIs were reported. The action may for instance involve bandwidth throttling for one or more user equipment(s) in the specific location including the user equipment(s) for which congestion was reported.

FIG. 2 is a schematic diagram illustrating a specific location 25. The specific location 25 is served by at least one RAN node, in FIG. 2 exemplified by RN 22. The RN 22 is configured to serve user equipment 23, in FIG. 2 exemplified by user equipment 23a, 23b, and 23c. User equipment 23a represents user equipment in connected state. User equipment 23b represents user equipment in idle state but previously in connected state in the specific location 25. User equipment 23c represents user equipment in idle state only in the specific location 25. As the skilled person understands, the specific location 25 of FIG. 2 may comprise a plurality of user equipment 23a in connected state, a plurality of user equipment 23b in idle state but previously in connected state in the specific location 25, and/or a plurality of user equipment 23c in idle state only in the specific location 25.

In general terms, the request sent from the RCAF 12 to the MM node 21 of what user equipment 23, 23a, 23b, 23c that are in connected state at a certain point in time may be regarded as a snapshot that does not necessarily represent user equipment 23, 23a, 23b, 23c that will be in connected state during the time period between two notifications sent from the RCAF node 12 to the PCRF 13 (see the solution 1.5.5 in 3GPP TR 23.705 discussed above in the Background section). This is because user equipment 23, 23a, 23b, 23c change state between idle state and connected state more frequent than the periodicity of the notification sent messages to the PCRF 13. It may thus become more or less random which user equipment 23, 23a, 23b, 23c the request from the RCAF node 12 to the MM node 21 will manage to fetch in the connected state.

In more detail, the inventors of the herein disclosed embodiments have realized that the user equipment 23a being in connected state precisely when the RCAF node 12 requests the information from the MM node 21 is most certainly limited because user equipment 23 may go from idle state to connected state (and vice versa) more frequent than the repetition time of the reporting from the MM node 21. Commonly, at a particular point in time, very few user equipment 23a are in connected state. Thus, there is a possibility that, during the time between two congestion report notification messages between the RCAF node 12 and the PCRF 13, more user equipment will go up to connected state.

The embodiments disclosed herein are based on increasing, or aggregating, the number of user equipment 23, 23a, 23b, 23c as basis for taking action on (or prohibit taking wrong action on) in the PCRF 13. The increase is per each repetitive congestion notification sent from the RCAF node 12 to the PCRF 13. The increase is enabled by considering also the user equipment being in idle state in the specific location 25. Hence, user equipment 23b in idle state but previously in connected state in the specific location are also identified in the notification sent from the RCAF node 12 to the PCRF 13. If such notifications are not sent the user equipment 23b would have wrongly been reported as having congestion=o (e.g. corresponding to no congestion or low congestion or negligible congestion or similar), and the PCRF 13 would have set a PCC rule accordingly.

More and more user equipment may thus be added for every notification message from the RCAF node 12 to the PCRF 13. Once a user equipment leaves the specific location 25 it is no longer included in the notification message (more specifically, it may be reported as having left the specific location 25). Thereby all network nodes (such as the RAN node 22, the MM node 21, the RCAF node 12, and the PCRF 12) have the same, or at least very similar, view of all user equipment ever found as connected in the specific location 25.

The embodiments disclosed herein thus relate to mobility management of user equipment 23, 23a, 23b. In order to obtain such mobility management there is provided an RCAF node 12, a method performed by the RCAF node 12, a computer program comprising code, for example in the form of a computer program product, that when run on a processing unit of the RCAF node 12, causes the processing unit to perform the method. In order to obtain such mobility management there is further provided mobility management node 21, 11a, 11b, a method performed by mobility management node 21, 11a, 11b, a computer program comprising code, for example in the form of a computer program product, that when run on a processing unit of the mobility management node 21, 11a, 11b, causes the processing unit to perform the method.

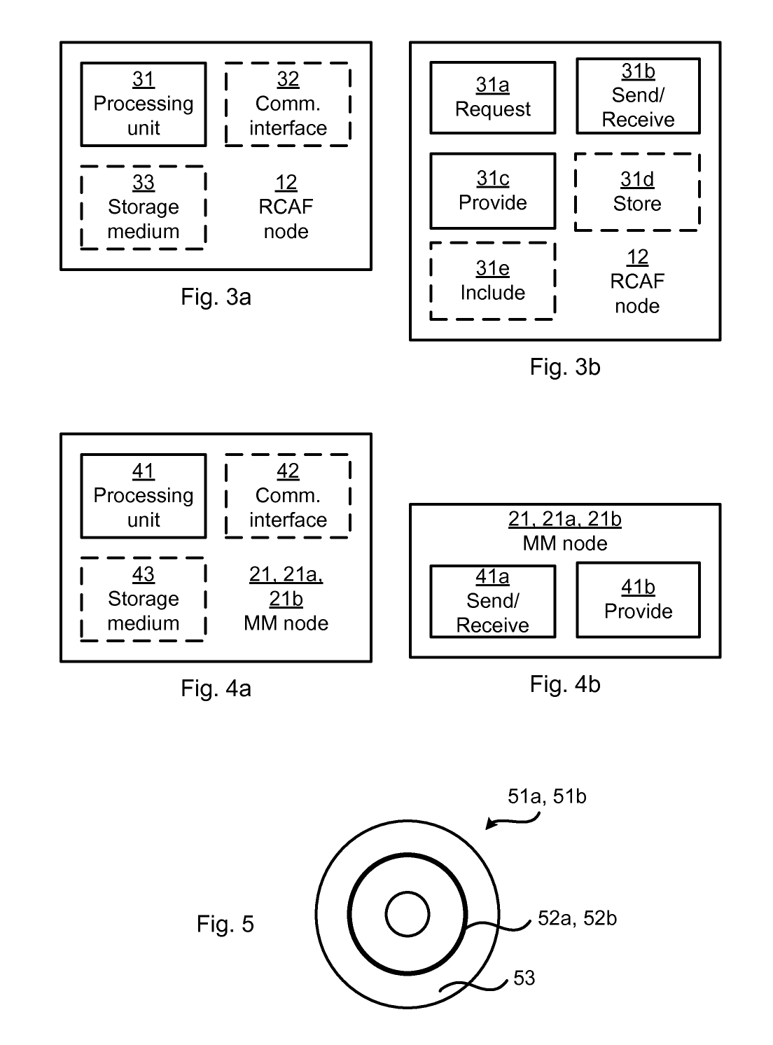

FIG. 3a schematically illustrates, in terms of a number of functional units, the components of a radio access network congestion awareness function (RCAF) node 12 according to an embodiment. A processing unit 31 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 51a (as in FIG. 5), e.g. in the form of a storage medium 33. Thus the processing unit 31 is thereby arranged to execute methods as herein disclosed. The storage medium 33 may also comprise persistent storage, which, for example, can be any single one or combination of magnetic memory, optical memory, solid state memory or even remotely mounted memory. The RCAF node 12 may further comprise a communications interface 32 for communications with other entities and devices of the communications network to over interfaces such as any of Np (to the PCRF 13), Nq, Nq′ (to the mobility management node 21), and an interface to an RAN OAM 15. The processing unit 31 controls the general operation of the RCAF node 12 e.g. by sending data and control signals to the communications interface 32 and the storage medium 33, by receiving data and reports from the communications interface 32, and by retrieving data and instructions from the storage medium 33. Other components, as well as the related functionality, of the RCAF node 12 are omitted in order not to obscure the concepts presented herein.

FIG. 3b schematically illustrates, in terms of a number of functional modules, the components of a RCAF node 12 according to an embodiment. The RCAF node 12 of FIG. 3b comprises a request module 31a, a send/and or receive module 31b, and a provide module sic. The RCAF node 12 of FIG. 4b may further comprises a number of optional functional modules, such as any of a determine store module sic, and an include module 31e. The functionality of each functional module 31a-e will be further disclosed below in the context of which the functional modules 31a-e may be used. In general terms, each functional module 31a-e may be implemented in hardware or in software. Preferably, one or more or all functional modules 31a-e may be implemented by the processing unit 31, possibly in cooperation with functional units 32 and/or 33. The processing unit 31 may thus be arranged to from the storage medium 33 fetch instructions as provided by a functional module 31a-e and to execute these instructions, thereby performing any steps of the RCAF node 12 as will be disclosed hereinafter.

FIG. 4a schematically illustrates, in terms of a number of functional units, the components of a mobility management (MM) node 21, 11a, 11b according to an embodiment. A processing unit 41 is provided using any combination of one or more of a suitable central processing unit (CPU), multiprocessor, microcontroller, digital signal processor (DSP), application specific integrated circuit (ASIC), field programmable gate arrays (FPGA) etc., capable of executing software instructions stored in a computer program product 51b (as in FIG. 5), e.g. in the form of a storage medium 43. Thus the processing unit 41 is thereby arranged to execute methods as herein disclosed. The storage medium 43 may also comprise persistent storage, which, for example, can be any single one or combination of magnetic memory, optical memory, solid state memory or even remotely mounted memory. The mobility management node 21, 11a, 11b may further comprise a communications interface 42 for communications with other entities and devices of the communications network 10 over interfaces such as any of S1-MME, Iu (to the RAN 16), Nq, Nq′ (to the RCAF node 12), and S11, S4 (to the SGW 17). The processing unit 41 controls the general operation of the mobility management node 21, 11a, 11b e.g. by sending data and control signals to the communications interface 42 and the storage medium 43, by receiving data and reports from the communications interface 42, and by retrieving data and instructions from the storage medium 43. Other components, as well as the related functionality, of the mobility management node 21, 11a, 11b are omitted in order not to obscure the concepts presented herein.

FIG. 4b schematically illustrates, in terms of a number of functional modules, the components of a mobility management node 21, 11a, 11b according to an embodiment. The mobility management node 21, 11a, 11b of FIG. 4b comprises a send and/or receive module 41a, and a provide module 41b. The mobility management node 21, 11a, 11b of FIG. 3b may further comprise a number of optional functional modules. The functionality of each functional module 41a-b will be further disclosed below in the context of which the functional modules 41a-b may be used. In general terms, each functional module 41a-b may be implemented in hardware or in software. Preferably, one or more or all functional modules 41a-b may be implemented by the processing unit 41, possibly in cooperation with functional units 42 and/or 43. The processing unit 41 may thus be arranged to from the storage medium 43 fetch instructions as provided by a functional module 41a-b and to execute these instructions, thereby performing any steps of the mobility management node 21, 11a, 11b as will be disclosed hereinafter.

The mobility management node 21, 11a, 11b may be provided as a standalone device or as a part of a further device. For example, as noted above, the mobility management node 21, 11a, 11b may be provided in a Mobility Management Entity (MME) 11a. For example, as also noted above, the mobility management node 21, 11a, 11b may be provided in a Serving General packet radio service Support Node (SGSN) 11b. Hence the herein disclosed mobility management node 21, 11a, 11b may incorporate the functionality of the MME 11a and/or the SGSN 11b and may thus replace the MME 11a and/or the SGSN 11b.

FIG. 5 shows one example of a computer program product 51a, 51b comprising computer readable means 53. On this computer readable means 53, a computer program 52a can be stored, which computer program 52a can cause the processing unit 31 of the RCAF node 12 and thereto operatively coupled entities and devices, such as the communications interface 32 and the storage medium 33, to execute methods according to embodiments described herein. On this computer readable means 53, a computer program 52b can be stored, which computer program 52b can cause the processing unit 41 of the mobility management node 21, 11a, 11b and thereto operatively coupled entities and devices, such as the communications interface 42 and the storage medium 43, to execute methods according to embodiments described herein. The computer programs 52a, 52b and/or computer program products 51a, 51b may thus provide means for performing any steps 3o as herein disclosed.

In the example of FIG. 5, the computer program product 51a, 51b is illustrated as an optical disc, such as a CD (compact disc) or a DVD (digital versatile disc) or a Blu-Ray disc. The computer program product 51a, 51b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory. Thus, while the at least one computer program 52a, 52b is here schematically shown as a track on the depicted optical disk, the at least one computer program 52a, 52b can be stored in any way which is suitable for the computer program product 51a, 51b.

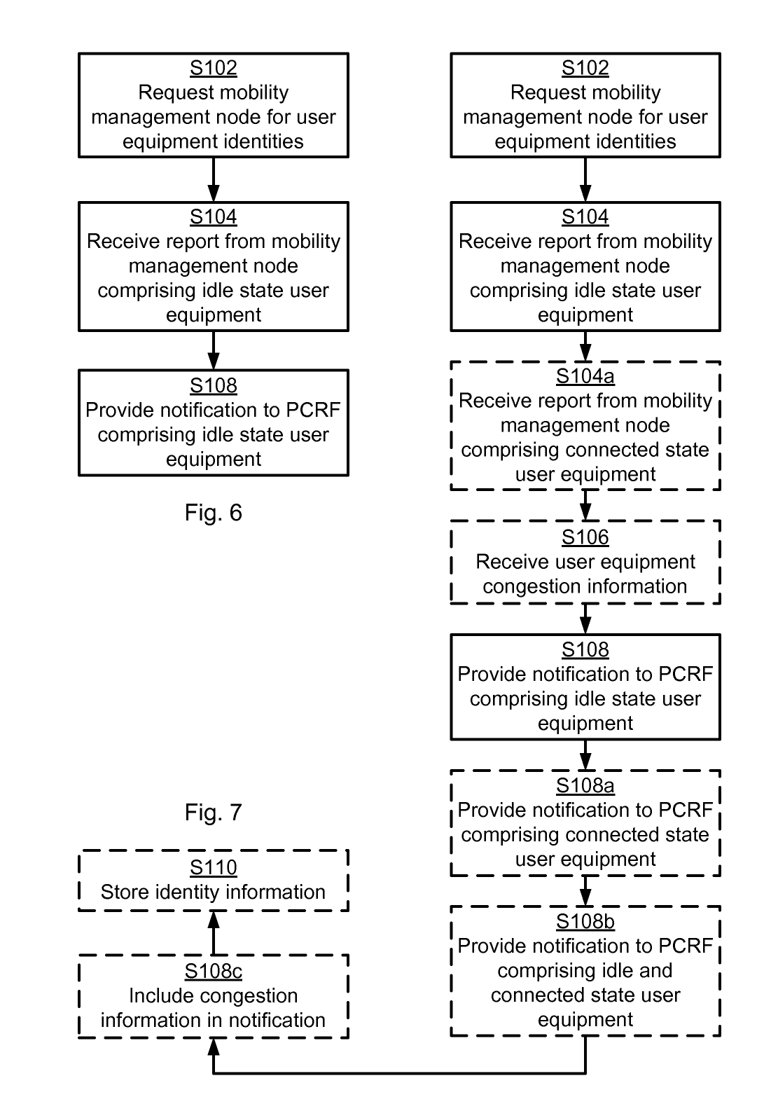

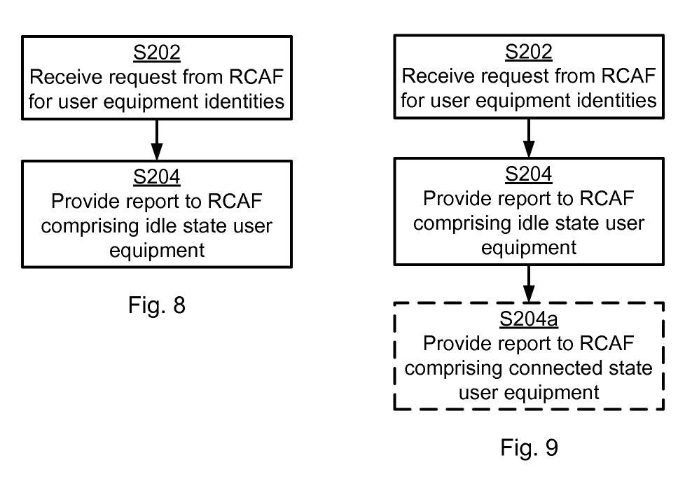

FIGS. 6 and 7 are flow charts illustrating embodiments of methods for mobility management of user equipment as performed by the RCAF node 12. FIGS. 8 and 9 are flow charts illustrating embodiments of methods for mobility management of user equipment as performed by the mobility management node 21, 11a, 11b. The methods are advantageously provided as computer programs 52a, 52b.

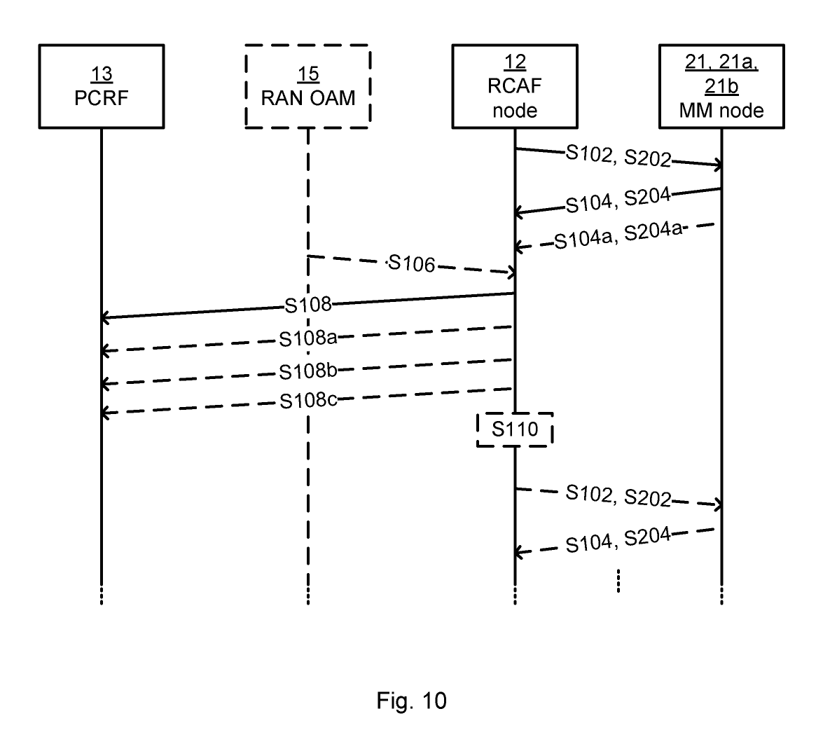

Reference is now made to FIG. 6 illustrating a method for mobility management of user equipment 23, 23a, 23b as performed by an RCAF node 12 according to an embodiment. Parallel reference is made to the signalling diagram of FIG. 10.

S102: The RCAF node 12 requests, from a mobility management node 11a, 11b, 21, user equipment identities for user equipment 23, 23a, 23b in a specific location 25. The user equipment identities pertain to user equipment currently in connected state and current state of user equipment previously in connected state. However, the request as such may be neutral or decisive with respect to whether the user equipment in question are, or should be, in any particular state (e.g. in connected state or idle state). Rather, it is the mobility management node 11a that decides to reply (see step S104 and particular S204 below) with at least the identities of user equipment that have been in connected state and possibly also with identities of user equipment that currently are in connected state. The RCAF node 12 may be configured to perform step S102 by the processing unit 31 executing functionality of the request module 31a. The computer program 52a and/or computer program product 51a may thus provide means for this step.

Further details regarding how this request may be formulated will be provided below. The request may be received by the mobility management node 11a, 11b, 21 as in step S202 below.

S104: The RCAF node 12 receives, from the mobility management node 11a, 11b, 21, a report comprising user equipment identity information (UEII) pertaining at least to idle state user equipment as identifiable by the mobility management node 11a, 11b, 21 in the specific location 25. Thus, in other words the report comprises UEII pertaining at least to user equipment with current state “previously in connected state”. The report may also comprises UEII pertaining to user equipment currently in connected state. The RCAF node 12 may be configured to perform step S104 by the processing unit 31 executing functionality of the send/and receive module 31b. The computer program 52a and/or computer program product 51a may thus provide means for this step. The report may be sent by the mobility management node 11a, 11b, 21 as in step S204 below.

S108: The RCAF node 12 provides a notification comprising the UEII to a policy and charging rules function (PCRF) 13. The RCAF node 12 may be configured to perform step S108 by the processing unit 31 executing functionality of the provide module sic. The computer program 52a and/or computer program product 51a may thus provide means for this step.

In this respect it should be noted that it may not be the identities (of the user equipment) themselves that are reported by the mobility management node 11a, 11b, 21 but rather a change from the last reporting from the mobility management node 11a, 11b, 21. The UEII provided to the PCRF 13 may thus identify only user equipment that have changed state (i.e., form idle state to connected state, or vice versa) in the specific location 25. Hence, if there are not any user equipment in the specific location that fulfill the criterion for being included in the UEII, the notification to the PCRF 13 may be empty.

In this respect it should be further noted that the UEII may only be related to such user equipment that have previously been in connected state in the specific location 25 but have changed state to idle state in the specific location 25 without leaving the specific location 25. Such user equipment may be defined as having available user equipment identity information at the mobility management node 11a, 11b, 21. User equipment that has never been in connected state in the specific location 25 will not be identified by the mobility management node 11a, 11b, 21.

The RCAF node 12 may thus use the collected UEII received from the mobility management node 11a, 11b, 21 to, at some point in time, provide it to the PCRF 13, for example by including the UEII in a congestion notification sent to the PCRF 13 (see below). Since the congestion notification thereby may contain information from all user equipment ever found connected (i.e. those that ever have been reported to the PCRF 13 in the specific location 25 and that remain in the specific location, the basis for the PCRF 13 to take correct PCC action is increased. The PCRF 13 thereby has added information to consider when it takes action (a policy decision). By using the information from IMSIs already known by the PCRF 13 the toggling in the Gx signaling may be decreased.

There may be different types of information that is included in the UEII. For example, the UEII may identify user equipment that remain in the specific location 25. For example, the UEII may identify user equipment that have moved to a new specific location. For example, the UEII may comprise state change information of user equipment in the specific location 25. For example, the UEII may identify a last known location for each user equipment associated with the UEII. The user equipment with identified last known locations may be in connected state.

If a user equipment 23b is found in idle state and has already been reported connected in the same specific location 25 then the RCAF node 12 may treat it as it would have been reported as in connected state in the specific location 25. If a user equipment is found in connected state but with a different specific location then the RCAF node 12 may treat it as if the user equipment would have been connected in that different specific location.

There may be different ways to provide the user equipment identities. For example, each user equipment identity may be represented by an International Mobile Subscriber Identity (IMSI).

There may be different ways to identify the specific location 25. For example, the specific location 25 may be is associated with at least one of a specific radio access network (RAN) node 22, a specific cell, a specific service area identifier, and/or a specific routing area identifier.

There may be different ways for the RCAF node 12 to formulate the request sent in step S102. Different embodiments relating thereto will now be described in turn.

For example, the request may pertain to information indicating active access point names (APNs) associated with the user equipment identities for the user equipment in the specific location 25.

Reference is now made to FIG. 7 illustrating methods for mobility management of user equipment 23, 23a, 23b as performed by an RCAF node 12 according to further embodiments. Parallel reference is continued to the signalling diagram of FIG. 10.

The request in step S102 may pertain to information indicating the user equipment identities for connected state and/or idle state user equipment in the specific location 25. The request in step S102 may thus pertain to information indicating the user equipment identities only for connected state user equipment in the specific location 25. Hence, although the RCAF node 12 in step S102 requests connected user equipment, the RCAF node 12 in step S104 receives a list at least of idle user equipment. However, the RCAF node 12 may further receive information regarding connected state user equipment, as in optional step S104a:

S104a: The RCAF node 12 may further receive, from the mobility management node 21, 11a, 11b, a report comprising the UEII pertaining to the user equipment identity of at least one connected state user equipment 23a as identifiable by the mobility management node 21, 11a, 11b in the specific location 25. The RCAF node 12 may be configured to perform step S104a by the processing unit 31 executing functionality of the send/and receive module 31b.

The RCAF node 12 may then provide the PCRF 13 also with this information, as in optional step S108a:

S108a: The RCAF node 12 may provide the PCRF 13 with a notification comprising the UEII pertaining to the user equipment identity of the at least one connected state user equipment 23a in the specific location. The RCAF node 12 may be configured to perform step S108a by the processing unit 31 executing functionality of the provide module 31c.

In general terms, there may be different ways for the RCAF node 12 to provide the notification, or notifications, to the PCRF 13. For example, the RCAF node 12 may explicitly report which user equipment are in connected state and which user equipment are in idle state, as in optional step S108b:

S108b: The RCAF node 12 may provide the PCRF 13 with a notification comprising UEII about which user equipment 23a are in connected state and which user equipment 23b are in idle state in the specific location 25. The RCAF node 12 may be configured to perform step S108b by the processing unit 31 executing functionality of the provide module 31c.

It may be preferred that the notification 108 sent from the RCAF node 12 to the PCRF 13 is provided in a congestion notification, preferably comprising user equipment congestion information pertaining to the user equipment indicated by the UEII. Thus, the UEII provided by the RCAF node 12 to the PCRF 13 may be provided in a congestion notification. The RCAF node 12 may receive congestion information from a RAN OAM node 15, as in optional step S106, and then include such information in the notification sent to the PCRF 13, as in optional step S108c:

S106: The RCAF node 12 may receive a report comprising user equipment congestion information from a RAN OAM node 15. The RCAF node 12 may be configured to perform step S106 by the processing unit 31 executing functionality of the send/and receive module 31b

S108c: The RCAF node 12 may include the congestion information in the congestion notification. The RCAF node 12 may be configured to perform step S108c by the processing unit 31 executing functionality of the include module 31e.

Any user equipment congestion level changes may be identifiable in the user equipment congestion information. The UEII provided by the RCAF node 12 to the PCRF 13 may identify only user equipment that have changed congestion level.

The RCAF node 12 may store the UEII received from the mobility management node 11a, 11b, 21 for future reference, as in optional step S110:

S110: The RCAF node 12 may store the UEII received from the mobility management node 11a, 11b, 21. The RCAF node 12 may be configured to perform step S110 by the processing unit 31 executing functionality of the store module 31d.

In cases where the RCAF node 12 has access to such stored UEII the request to the mobility management node 11a, 11b, 21 as sent in step S102 may comprise previously stored UEII of the user equipment.

Reference is now made to FIG. 8 illustrating a method for mobility management of user equipment 23, 23a, 23b as performed by a mobility management node 11a, 11b, 21 according to an embodiment. Parallel reference is continued to the signalling diagram of FIG. 10.

S202: The mobility management node 11a, 11b, 21 receives, from an RCAF node 12, a request for user equipment identities for user equipment 23, 23a, 23b in a specific location 25. The user equipment identities pertain to user equipment currently in connected state and current state of user equipment previously in connected state. The mobility management node 11a, 11b, 21 may be configured to perform step S202 by the processing unit 41 executing functionality of the send and/or receive module 41a. The computer program 52b and/or computer program product 51b may thus provide means for this step. The request may have been sent by the RCAF node 25 as in step S102.

S204: The mobility management node 11a, 11b, 21 provides, to the RCAF node 12, a report comprising user equipment identity information (UEII) pertaining at least to idle state user equipment as identifiable by the mobility management node 11a, 11b, 21 in the specific location 25. The mobility management node 11a, 11b, 21 may be configured to perform step S204 by the processing unit 41 executing functionality of the provide module 41b. The computer program 52b and/or computer program product S1b may thus provide means for this step. The report may be received by the RCAF node 25 as in step S104.

The same notes as made above with reference to step S104 (regarding the UEII provided by the mobility management node 11a, 11b, 21 to the RCAF node 12) are also applicable here.

One single report may include all requested user equipment (IMSIs). Alternatively, one report may be sent per user equipment or for a group of user equipment.

As above, the request from the RCAF node 12 may pertain to information indicating active access point names associated with the user equipment identities for the user equipment in the specific location 25.

As above, the request from the RCAF node 12 may pertain to information indicating the user equipment identities for connected state user equipment in the specific location 25.

As above, the request from the RCAF node 12 may comprise UEII of user equipment as previously stored by the RCAF node 12.

As above, the UEII may identify user equipment that remain in the specific location 25.

As above, the UEII may identify user equipment that have moved to a new specific location.

As above, the UEII may comprise state change information of user equipment in the specific location 25.

As above, the UEII may identify a last known location for each user equipment associated with the UEII. As above, these user equipment may be in connected state.

As above, each user equipment identity may be represented by an International Mobile Subscriber Identity (IMSI).

As above, the specific location 25 may be associated with at least one of a specific radio access network (RAN) node 22, a specific cell, a specific service area identifier, and a specific routing area identifier.

Reference is now made to FIG. 9 illustrating methods for mobility management of user equipment 23, 23a, 23b as performed by a mobility management node 11a, 11b, 21 according to further embodiments. Parallel reference is continued to the signalling diagram of FIG. 10.

As above, although the RCAF node 12 in step S102 requests connected user equipment, the mobility management node 11a, 11b, 21 in step S204 provides a list at least of idle user equipment. However, the mobility management node 11a, 11b, 21 may further provide information regarding connected state user equipment, as in optional step S204a:

S204a: The mobility management node 11a, 11b, 21 may provide, to the RCAF node 12, a report comprising the UEII pertaining to the user equipment identity of at least one connected state user equipment 23a as identifiable by the mobility management node 11a, 11b, 21 in the specific location 25. The mobility management node 11a, 11b, 21 may be configured to perform step S204a by the processing unit 41 executing functionality of the provide module 41b. This report may be received by the RCAF node 12, as in optional step S104a.

Particular considerations for a possible scenario when implementing the herein disclosed embodiments in an LTE based communications network will now be disclosed.

During or after a request from the RCAF node 12 to the MME 11a of what UEs/IMSIs that are in a particular eNB/cell, the RCAF node 12 may either (a) attach the last known IMSIs of the eNB/cell in the same request (i.e., one request including both parts is sent to the MME 11a), or (b) send a following request with the previously reported connected IMSIs not responded back from the MME 11a included in the first request. That is, in option (b) two consecutive requests will be sent to the MME 11a.

The MME 11a may then respond back to the RCAF node 12 with the IMSIs with their last known locations (eNB/cell) where the user equipment were located the last time when the user equipment were in connected state. Included in the response may be: IMSI, location (eNB/cell), and information regarding state information (idle or connected) of the reported user equipment (or IMSI).

Particular considerations for a possible scenario when implementing the herein disclosed embodiments in a GPRS based communications network will now be disclosed.

In GPRS based communications networks the RCAF node 12 knows the IMSIs of the user equipment that are in connected state in a congested NB/cell.

To obtain the user equipment (IMSIs) that are in idle state the RCAF node 12 requests this information from the SGSN 11b in the same manner as for the LTE scenario above but where the MME 11a is replaced by the SGSN 11b.

For GPRS, the location of the user equipment (IMSI) is per service area identifier (SAT). It should also be considered that it could be per routing area identifier (RAI) or cell.

One particular embodiment based on at least some of the above disclosed general embodiments will now be disclosed.
1) The RCAF node 12 has a storage medium 33 storing information of which UEs/IMSIs that were found to be in connected state in a specific location 25 (such as associated with a particular eNB/cell) from previous requests (as in step S110). This stored information is based on all previously responses from the mobility management node 11a, 11b, 21.
2) The RCAF node 12 requests (as in step S102) from the mobility management node 11a, 11b, 21:
   (a) the connected user equipment in the specific location 25 and the corresponding active APNs; and
   (b) the idle state user equipment/IMSIs, as known by the RCAF node 12, and uses the IMSIs together with the specific location as input parameters to the mobility management node 11a, 11b, 21.
   If the mobility management node 21 is provided as an SGSN 11b only active APNs are requested.
3) This request is received by the mobility management node 11a, 11b, 21 (as in step S202). The mobility management node 11a, 11b, 21 responds (as in step S2o4) with:
   (a) UEs/IMSIs that remain in the requested specific location 25 (eNB/cell); and
   (b) UEs/IMSIs that have moved to a new specific location 25 (eNB/cell).
4) This response is received by the RCAF node 12 (as in step S104). The RCAF node 12 stores (as in step S110) the UEs/IMSIs in idle state for the specific location 25 (eNB/cell) to use in the following requests to the mobility management node 11a, 11b, 21.
5) The RCAF node 12 sends the UEs/IMSIs being in connected state and idle state for that specific location 25 (eNB/cell) to the PCRF 13 (as in step S108). The RCAF node 12 may only send the UEs/IMSIs that have changed their congestion level. The PCRF 13 will thereby be made aware of also the congestion state of all UEs/IMISs that in the specific location 25 have changed state from connected state to idle state, but are still located in the specific location 25.

Some embodiments described above may be summarized in the following manner:

One embodiment is directed to a method for mobility management and/or congestion management of user equipment. The method is performed by a radio access network congestion awareness function, RCAF, node. The method comprises the steps of:
requesting, from a mobility management node, user equipment identities for user equipment in a specific location, the user equipment identities pertaining to user equipment currently in connected state and current state of user equipment previously in connected state;
receiving, from the mobility management node, a report comprising user equipment identity information, UEII, pertaining at least to idle state user equipment as identifiable by the mobility management node in the specific location; and
providing a notification comprising the UEII to a policy and charging rules function, PCRF.

The UEII provided to the PCRF may only identify user equipment that have changed state in the specific location, e.g. changed state from connected to idle or from idle to connected.

The request may pertain to information indicating active access point names associated with the user equipment identities for the user equipment in the specific location.

The request may pertain to information indicating the user equipment identities for connected state user equipment in the specific location.

The method may further comprise:
receiving, from the mobility management node, a report comprising the UEII pertaining to the user equipment identity of at least one connected state user equipment as identifiable by the mobility management node in the specific location.

The method may further comprise:
Providing the PCRF with a notification comprising the UEII pertaining to the user equipment identity of at least one connected state user equipment in the specific location.

The method may further comprise:
providing the PCRF with a notification comprising UEII about which user equipment are in connected state and which user equipment are in idle state in the specific location.

The method may further comprise:
storing (S110) the UEII received from the mobility management node.

The request to the mobility management node may comprise previously stored UEII of the user equipment.

The UEII may identify user equipment that remain in the specific location.

The UEII may identify user equipment that have moved to a new specific location.

The UEII may comprise state change information of user equipment in the specific location.

The UEII may identify a last known location for each user equipment associated with the UEII.

The user equipment may be in connected state.

Each user equipment identity may be represented by an International Mobile Subscriber Identity, IMSI.

The specific location may be associated with at least one of a specific radio access network, RAN, node, a specific cell, a specific service area identifier, and a specific routing area identifier.

The UEII provided to the PCRF may be provided in a congestion notification.

The method may further comprise:
receiving a report comprising user equipment congestion information from a radio access network, RAN, operations, administration and management, OAM, node.

The method may further comprise:
including the congestion information in the congestion notification.

Any user equipment congestion level changes may be identifiable in the user equipment congestion information, and wherein the UEII provided to the PCRF identifies only user equipment that have changed congestion level. Another embodiment is directed to a method for mobility management and/or congestion management of user equipment. The method is performed by a mobility management node. The method comprises the steps of:
receiving, from a radio access network congestion awareness function, RCAF, node, a request for user equipment identities for user equipment in a specific location, the user equipment identities pertaining to user equipment currently in connected state and current state of user equipment previously in connected state; and
providing, to the RCAF node, a report comprising user equipment identity information, UEII, pertaining at least to idle state user equipment as identifiable by the mobility management node in the specific location.

The request may pertain to information indicating active access point names associated with the user equipment identities for the user equipment in the specific location.

The request may pertain to information indicating the user equipment identities for connected state user equipment in the specific location.

The method may further comprise:
providing, to the RCAF node, a report comprising the UEII pertaining to the user equipment identity of at least one connected state user equipment as identifiable by the mobility management node in the specific location.

The request may comprise UEII of user equipment as previously stored by the RCAF node.

The UEII may identify user equipment that remain in the specific location.

The UEII may identify user equipment that have moved to a new specific location.

The UEII may comprise state change information of user equipment in the specific location.

The UEII may identify a last known location for each user equipment associated with the UEII.

The user equipment may be in connected state.

Each user equipment identity may be represented by an International Mobile Subscriber Identity, IMSI.

The specific location may be associated with at least one of a specific radio access network, RAN, node, a specific cell, a specific service area identifier, and a specific routing area identifier.

Another embodiment is directed to a radio access network congestion awareness function, RCAF, node configured to operatively manage mobility and/or congestion of user equipment. The RCAF node comprises a processing unit configured to:
request, from a mobility management node, user equipment identities for user equipment in a specific location, the user equipment identities pertaining to user equipment currently in connected state and current state of user equipment previously in connected state;
receive, from the mobility management node, a report comprising user equipment identity information, UEII, pertaining at least to idle state user equipment as identifiable by the mobility management node in the specific location; and
provide a notification comprising the UEII to a policy and charging rules function, PCRF.

Another embodiment is directed to a mobility management node configured to operatively manage mobility and/or congestion of user equipment. The mobility management node comprises a processing unit configured to:
receive, from a radio access network congestion awareness function, RCAF, node, a request for user equipment identities for user equipment in a specific location, the user equipment identities pertaining to user equipment currently in connected state and current state of user equipment previously in connected state; and
provide, to the RCAF node, a report comprising user equipment identity information, UEII, pertaining at least to idle state user equipment as identifiable by the mobility management node in the specific location.

The mobility management node may be a Mobility Management Entity, MME.

The mobility management node may be a Serving General packet radio service Support Node, SGSN.

Another embodiment is directed to a computer program for mobility management of user equipment, the computer program comprising computer code which, when run on a processing unit, causes the processing unit to:
request, from a mobility management node, user equipment identities for user equipment in a specific location, the user equipment identities pertaining to user equipment currently in connected state and current state of user equipment previously in connected state;
receive, from the mobility management node, a report comprising user equipment identity information, UEII, pertaining at least to idle state user equipment as identifiable by the mobility management node in the specific location; and
provide a notification comprising the UEII to a policy and charging rules function, PCRF.

Another embodiment is directed to a computer program for mobility management of user equipment, the computer program comprising computer code which, when run on a processing unit, causes the processing unit to:
receive, from a radio access network congestion awareness function, RCAF, node, a request for user equipment identities for user equipment in a specific location, the user equipment identities pertaining to user equipment currently in connected state and current state of user equipment previously in connected state; and
provide, to the RCAF node, a report comprising user equipment identity information, UEII, pertaining at least to idle state user equipment as identifiable by the mobility management node in the specific location.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for mobility management of user equipment, the method being performed by a radio access network congestion awareness function, RCAF, node, the method comprising the steps of:
requesting, from a mobility management node (MMN), user equipment identities (UE IDs) for user equipments (UEs) in a specific location;
receiving a report transmitted by the MMN in response to the request for the UE IDs, the report comprising user equipment identity information, (UEII) comprising a least a first set of one or more UE IDs, wherein each one of the UE IDs included in said first set of UE IDs identifies a UE identified by the mobility management node as a) being in the idle state, b) being in the specific location and c) as having previously been in a connected state while located in the specific location; and
providing a notification comprising the UEII to a policy and charging rules function (PCRF).

2. The method of claim 1, wherein the UEII provided to the PCRF identifies only UEs that have changed state while in the specific location.

3. The method of claim 1, wherein the request pertains to one or both of: i) information indicating active access point names associated with the user equipment identities for the user equipment in the specific location and ii) information indicating the user equipment identities for connected state user equipment in the specific location.

4. (canceled)

5. The method claim 1, wherein the UEII further comprises a UE ID that identifies a UE that the mobility management node has determined is a) in the specific location and b) in the connected state.

6. (canceled)

7. The method of claim 1, further comprising:
providing the PCRF with a notification comprising UEII about which user equipment are in connected state and which user equipment are in idle state in the specific location.

8. (canceled)

9. The method of claim 1, wherein the request to the mobility management node comprises previously stored UEII.

10. The method of claim 1, wherein the UEII identifies one or more of: i) a user equipment that remains in the specific location and ii) a user equipment that has moved to a new specific location.

11. (canceled)

12. The method of claim 1, wherein the UEII comprises state change information of a user equipment in the specific location.

13. The method of claim 1, wherein the UEII identifies a last known location for a particular user equipment identified by the UEII.

14. The method of claim 13, wherein the particular user equipment is in the connected state.

15. The method of claim 1, wherein each user equipment identity is represented by an International Mobile Subscriber Identity (IMSI).

16. The method of claim 1, wherein the specific location is associated with at least one of: a specific radio access network (RAN) node, a specific cell, a specific service area identifier, and a specific routing area identifier.

17. The method of claim 1, wherein the UEII provided to the PCRF is provided in a congestion notification.

18. The method of claim 1, further comprising:
receiving a report comprising user equipment congestion information from a radio access network operations, administration and management node; and
including the congestion information in the congestion notification.

19. (canceled)

20. The method of claim 18, wherein any user equipment congestion level changes is identifiable in the user equipment congestion information, and wherein the UEII provided to the PCRF identifies only user equipment that have changed congestion level.

21. A method for mobility management of user equipments (UEs), the method comprising:
a mobility management node (MMN) receiving, from a radio access network congestion awareness function (RACF) node, a request for user equipment identities (UE IDs) for user equipments (UEs) in a specific location; and
the MMN, in response to the request from the RCAF node, providing, to the RCAF node, a report comprising user equipment identity information (UEII) comprising a least a first set of one or more UE IDs, wherein each one of the UE IDs included in said first set of UE IDs identifies a UE identified by the MMN as a) being in the idle state, b) being in the specific location and c) as having previously been in a connected state while located in the specific location.

22. The method of claim 21, wherein the request pertains to one or both of: a) information indicating active access point names associated with the user equipment identities for the user equipment in the specific location and b) information indicating the user equipment identities for connected state user equipment in the specific location.

23. (canceled)

24. The method of claim 21,
wherein the UEII further comprises a UE ID that identifies a UE that the mobility management node has determined is a) in the specific location and b) in the connected state.

25. The method of claim 21, wherein the request comprises UEII previously stored by the RCAF node.

26. The method of claim 21, wherein the UEII identifies one or both of: i) a user equipment that remains in the specific location and ii) a user equipment that has moved to a new specific location.

27. (canceled)

28. The method of claim 21, wherein the UEII comprises state change information of a user equipment in the specific location.

29. The method of claim 21, wherein the UEII identifies a last known location for a particular user equipment identified by a UE ID included in the UEII.

30. The method of claim 29, wherein the particular user equipment is in the connected state.

31. The method of claim 21, wherein each user equipment identity is represented by an International Mobile Subscriber Identity.

32. The method of claim 21, wherein the specific location is associated with at least one of a specific radio access network node, a specific cell, a specific service area identifier, and a specific routing area identifier.

33. A radio access network congestion awareness function (RCAF) node for mobility management of user equipment, the RCAF node comprising:
a memory; and
a processing unit coupled to the memory, wherein the processing unit is configured to:
request, from a mobility management node (MMN), user equipment identities (UE IDs) for user equipments (UEs) in a specific location;
obtain a report transmitted by the MMN in response to the request for the UE IDs, the report comprising user equipment identity information (UEII) comprising a least a first set of one or more UE IDs, wherein each one of the UE IDs included in said first set of UE IDs identifies a UE identified by the mobility management node as a) being in the idle state, b) being in the specific location and c) as having previously been in a connected state while located in the specific location; and
provide a notification comprising the UEII to a policy and charging rules function (PCRF).

34. A mobility management node (MMN) for mobility management of user equipment, the MMN comprising:
a memory; and
a processing unit coupled to the memory, wherein the processing unit is configured to:
obtain, from a radio access network congestion awareness function (RACF) node, a request for user equipment identities (UE IDs) for user equipments (UEs) in a specific location; and
in response to the request from the RCAF node, provide, to the RCAF node, a report comprising user equipment identity information (UEII) comprising a least a first set of one or more UE IDs, wherein each one of the UE IDs included in said first set of UE IDs identifies a UE identified by the MMN as a) being in the idle state, b) being in the specific location and c) as having previously been in a connected state while located in the specific location.

35. The mobility management node of claim 34, wherein the mobility management node is one of: a Mobility Management Entity and a Serving General packet radio service Support Node.

36. (canceled)

37. A non-transitory computer readable medium storing a computer program for mobility management of user equipment, the computer program comprising computer code which, when run on a processing unit, causes the processing unit to:
request, from a mobility management node (MMN), user equipment identities (UE IDs) for user equipments (UEs) in a specific location;
obtain a report transmitted by the MMN in response to the request for the UE IDs, the report comprising user equipment identity information (UEII) comprising a least a first set of one or more UE IDs, wherein each one of the UE IDs included in said first set of UE IDs identifies a UE identified by the mobility management node as a) being in the idle state, b) being in the specific location and c) as having previously been in a connected state while located in the specific location; and
provide a notification comprising the UEII to a policy and charging rules function (PCRF).

38. A non-transitory computer readable medium storing a computer program for mobility management of user equipment, the computer program comprising computer code which, when run on a processing unit, causes the processing unit to:
obtain, from a radio access network congestion awareness function (RACF) node, a request for user equipment identities (UE IDs) for user equipments (UEs) in a specific location; and
in response to the request from the RCAF node, provide, to the RCAF node, a report comprising user equipment identity information (UEII) comprising a least a first set of one or more UE IDs, wherein each one of the UE IDs included in said first set of UE IDs identifies a UE identified by the processing unit as a) being in the idle state, b) being in the specific location and c) as having previously been in a connected state while located in the specific location.

39. (canceled)
